(19) United States
(12) Patent Application Publication
(10) Pub. No.: US 2007/0236473 A1
(43) Pub. Date: Oct. 11, 2007

(54) MOUNTING ASSEMBLY FOR TOUCHPAD

(75) Inventors: LIN-YUN HONG, Shenzhen (CN); HSUAN-CHEN CHEN, Tu-Cheng (TW); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,159

(22) Filed: Dec. 15, 2006

(30) Foreign Application Priority Data
Apr. 5, 2006 (CN) 200620013423.8

(51) Int. Cl. G06F 3/041

(52) U.S. Cl. 345/173

(57) ABSTRACT

A mounting assembly for mounting a touchpad to an electronic device is provided. The electronic device includes a plate defining a through opening for exposing the touchpad. The mounting assembly includes a plurality of fastening portions arranged on the plate of the electronic device, and a fixing member fixable to the plate of the electronic device by the fastening portions. The fixing member is configured for sandwiching the touchpad between the fixing member and the plate of the electronic device. The fixing member includes at least one elastic tab configured for constantly abutting against the touchpad toward the plate.

### BACKGROUND OF THE INVENTION

1. Field of the Invention

The present invention relates to a mounting assembly for a touchpad.

2. Description of Related Art

A touchpad is typically mounted on an electronic device, such as a notebook computer. A touch-sensitive surface of the touchpad is touched by fingers of a user for moving a cursor displayed on a screen of the notebook computer or to select choices from menus displayed on the screen. Generally, the notebook computer includes a top plate. A fixing plate is mounted to an inner surface of the top plate by screws. The touchpad is sandwiched between the fixing plate and the top plate of the notebook computer. However, a small clearance between the fixing plate and the touchpad due to a distortion of the fixing plate or manufacturing errors may occur. Thus, the touchpad may be prone to move upon touching thereby affecting good control of the cursor.

What is desired, therefore, is a mounting assembly for a touchpad which can firmly mount the touchpad to an electronic device.

### SUMMARY OF THE INVENTION

An exemplary mounting assembly for mounting a touchpad to an electronic device is provided. The electronic device includes a plate defining a through opening for exposing the touchpad. The mounting assembly includes a plurality of fastening portions arranged on the plate of the electronic device, and a fixing member fixable to the plate of the electronic device by the fastening portions. The fixing member is configured for sandwiching the touchpad between the fixing member and the plate of the electronic device. The fixing member includes at least one elastic tab configured for constantly abutting against the touchpad toward the plate.

Other advantages and novel features will become more apparent from the following detailed description when taken in conjunction with the accompanying drawing, in which:

### BRIEF DESCRIPTION OF THE DRAWING

FIG. 1 is an inverted, exploded, isometric view of a mounting assembly for a touchpad in accordance with a preferred embodiment of the present invention; and

FIG. 2 is an assembled view of FIG. 1.

### DETAILED DESCRIPTION OF THE INVENTION

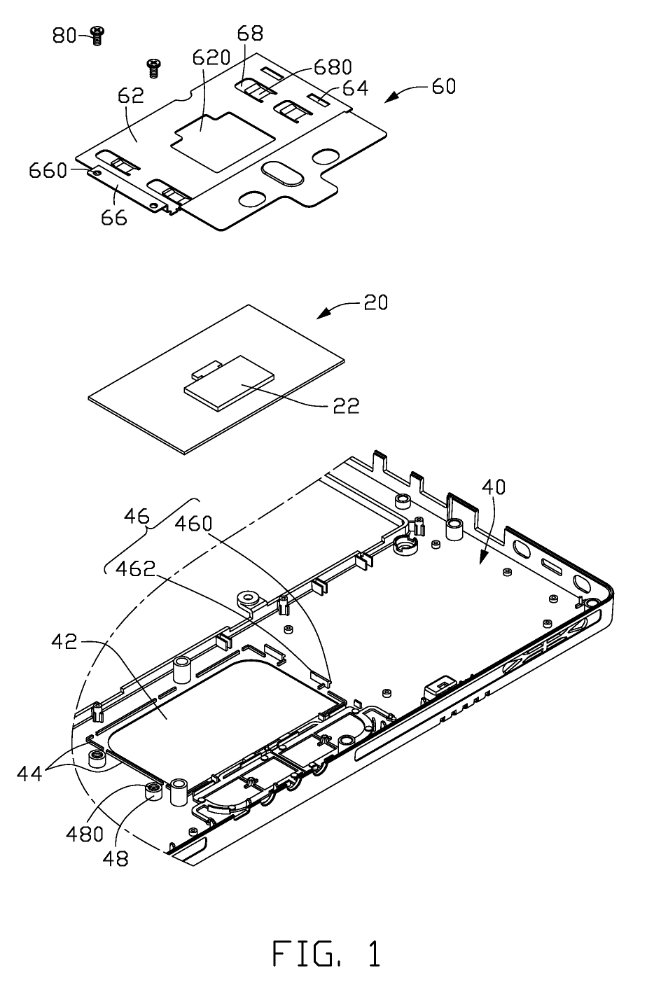

Referring to FIG. 1, a mounting assembly for a touchpad 20 in accordance with a preferred embodiment of the present invention is shown. The touchpad 20 is a rectangular touch-sensitive plate, including a connector 22 on a rear surface thereof. The mounting assembly includes a top plate 40 of a notebook computer, and a fixing member 60.

The top plate 40 defines an opening 42 therein. A plurality of ribs 44 is formed on an inner surface of the top plate 40 adjacent edges of the opening 42. The ribs 44 define therebetween a rectangular region for receiving the touchpad 20. A touch-sensitive surface of the touchpad 20 is exposed from the opening 42 of the top plate 40 for being touched by a user. Two locking portions 46 are formed on the top plate 40 adjacent an end of the opening 42. Each locking portion 46 includes an elastic arm 462 and a clasp 460 facing away from the opening 42. The elastic arm 462 extends from the top plate 42. The clasp 460 is formed on a distal end of the elastic arm 462 of the locking portion 46. Two fixing posts 48 protrude from the top plate 40 adjacent an opposite end of the opening 42. Each fixing post 48 defines a threaded hole 480 in a distal end thereof.

The fixing member 60 includes a thin fixing plate 62. A through hole 620 is defined in the fixing plate 62, corresponding to the connector 22 of the touchpad 20. Two slots 64 are defined in an end of the fixing plate 62, corresponding to the locking portions 46 of the top plate 40 respectively. An L-shaped fixing tab 66 extends from an opposite end of the fixing plate 62. The fixing tab 66 includes a connecting portion extending perpendicularly from one edge of the fixing plate 62, and a fixing portion extending perpendicularly from a distal edge of the connecting portion. The fixing portion is parallel to the fixing plate 62. Two round holes 660 are defined in the fixing tab 66 corresponding to the fixing posts 48 respectively. A plurality of apertures 68 is defined in the fixing plate 62, and an elastic tab 680 is formed in each aperture 68. The elastic tabs 680 are slightly bent below the fixing plate 62 from the corresponding apertures 68.

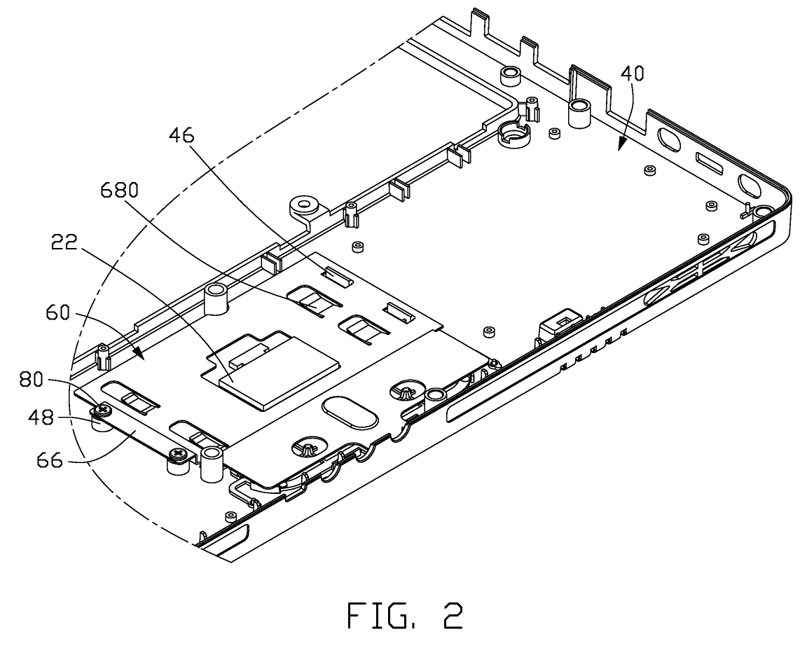

Referring to FIG. 2, in assembly, the touchpad 20 is received in the region defined by the ribs 44 of the top plate 40. The touchpad 20 is sandwiched between the ribs 44 in directions parallel to the touchpad 20. The clasps 460 of the top plate 40 extend through the corresponding slots 64 in the fixing plate 62 of the fixing member 60, and engage with the fixing plate 62. Two screws 80 extend through the corresponding round holes 660 in the fixing tab 66 of the fixing member 60, and engage in the corresponding threaded holes 480 in the fixing posts 48 of the top plate 40. The elastic tabs 680 abut against the rear surface of the touchpad 20. The fixing plate 62 cooperates with the top plate 40 to sandwich the touchpad 20 therebetween in a direction perpendicular to the touchpad 20. Thus, the fixing member 60 is firmly fixed to the top plate 40. The connector 22 of the touchpad 20 extends through the through hole 620 for electrically connecting with the notebook computer. The touch-sensitive surface of the touchpad 20 is exposed from the opening 42 of the top plate 40 for being touched by a user.

In other embodiments, the touchpad 20 can be attached to another plate of the notebook computer or a plate of another electronic device. The fixing member 60 can be fixed to the top plate 40 by other fastening portions, such as locking pins, and so on.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A mounting assembly for mounting a touchpad to an electronic device, the electronic device comprising a plate, the mounting assembly comprising:
a plurality of fastening portions arranged on the plate of the electronic device; and
a fixing member fixable to the plate of the electronic device by the fastening portions and configured for sandwiching the touchpad between the fixing member and the plate of the electronic device, the fixing member comprising at least one elastic tab configured for constantly abutting against the touchpad toward the plate.

2. The mounting assembly as claimed in claim 1, wherein the fixing member defines at least one aperture, the at least one elastic tab extends from the fixing member in the at least one aperture.

3. The mounting assembly as claimed in claim 1, wherein the fastening portions comprise two locking portions, each of the locking portions forms a clasp on a distal end thereof, the fixing member defines two slots therein, the clasps of the locking portions extend through the corresponding slots of the fixing member, and engage with the fixing member.

4. The mounting assembly as claimed in claim 1, wherein the fastening portions comprise two fixing posts, each of the fixing posts defines a threaded hole in a distal end thereof, the fixing member defines two round holes therein, two screws extend through the corresponding round holes of the fixing member, and engage in the corresponding threaded holes of the fixing posts.

5. The mounting assembly as claimed in claim 4, wherein the fixing member forms an L-shaped fixing tab, the round holes are defined in the fixing tab.

6. An electronic device, comprising:
a top plate comprising an opening defined therein;
a touchpad in alignment with the opening of the top plate and being touchable from a top side of the top plate via the opening; and
a fixing member fixing the touchpad to the top plate, the fixing member comprising a plurality of elastic tabs urging against the touchpad toward the top plate thereby retaining the touchpad in a steady state when the touchpad is touched.

7. The electronic device as claimed in claim 6, wherein the fixing member comprises a thin plate defining a plurality of apertures, and the elastic tabs are slightly bent below the thin plate from the corresponding apertures.

8. The electronic device as claimed in claim 6, wherein at least one clasp is formed adjacent an end of the opening of the top plate, the fixing member defines at least one slot, the at least one clasp of the top plate extends through the at least one slot, and engages with the fixing member, the touchpad being sandwiched between the fixing member and the top plate.

9. The electronic device as claimed in claim 8, wherein the top plate forms at least one locking portion, the at least one locking portion comprises an elastic arm extending from the top plate, the at least one clasp is formed on a distal end of the elastic arm and faces away from the opening of the top plate.

10. The electronic device as claimed in claim 9, wherein at least one fastening portion is formed adjacent an opposite end of the opening of the fixing member, and at least one round hole corresponding to the at least one fastening portion of the top plate for fixing the fixing member to the top plate is defined in the fixing member.

11. The electronic device as claimed in claim 9, wherein the at least one fastening portion comprises a fixing post defining a threaded hole, a screw extends through the round hole of the fixing member, and engages in the threaded hole of the fixing post.

12. The electronic device as claimed in claim 6, wherein the touchpad comprises a connector on a rear surface thereof, the fixing member defines a through hole therein, the connector of the touchpad extends through the through hole of the fixing member for electrically connecting with the electronic device.

13. The electronic device as claimed in claim 6, wherein a plurality of ribs is formed on an inner surface of the top plate adjacent edges of the opening, the ribs define therebetween a rectangular region for receiving the touchpad.

14. An electronic device comprising:
a top plate comprising an opening defined therethrough and a plurality of ribs formed at an inner surface thereof, the ribs surrounding the opening;
a touchpad sandwiched between the ribs in directions parallel to the touchpad, the touchpad being in alignment with the opening of the top plate and being touchable from a top side of the top plate via the opening; and
a fixing member for fixing the touchpad to the top plate, the fixing member comprising a fixing plate cooperating with the top plate to sandwich the touchpad therebetween in a direction perpendicular to the touchpad, and a plurality of elastic structures sandwiched between the fixing plate and the touchpad urging against the touchpad toward the top plate thereby retaining the touchpad in a steady state when the touchpad is touched.

15. The electronic device as claimed in claim 14, wherein the elastic structures comprises a plurality of elastic tabs stamped from the fixing plate.

16. The electronic device as claimed in claim 15, wherein the elastic tabs are arranged adjacent to two opposite ends of the touchpad.

17. The electronic device as claimed in claim 15, wherein a locking portion extends from the inner surface of the top plate adjacent to one end of the touchpad and forms a clasp on a distal end thereof, the fixing plate defines a slot therein, and the clasp of the locking portion extends through the slot of the fixing member to engage with the fixing plate.

18. The electronic device as claimed in claim 17, wherein a fixing post extends from the inner surface of the top plate adjacent to an opposite end of the touchpad and defines a threaded hole therein, the fixing plate defines a through hole therein, and a screw extends through the through hole of the fixing member to engage in the threaded hole.

19. The electronic device as claimed in claim 18, wherein the fixing plate forms an L-shaped fixing tab on which the through hole is defined, the fixing tab comprising a connecting portion extending perpendicularly from one edge of the fixing plate and a fixing portion extending perpendicularly from a distal edge of the connecting portion, the fixing portion being parallel to the fixing plate and abutting against the fixing post.
